(19) United States
(12) Patent Application Publication
(10) Pub. No.: US 2005/0225065 A1
(43) Pub. Date: Oct. 13, 2005

(54) Airbag and airbag system

(75) Inventor: Hiroaki Fujll, Hikone-shi (JP)

Correspondence Address: FITCH EVEN TABIN AND FLANNERY, 120 SOUTH LA SALLE STREET, SUITE 1600, CHICAGO, IL, 60603-3406, US

(73) Assignee: Takata Corporation

(21) Appl. No.: 11/100,216

(22) Filed: Apr. 6, 2005

(30) Foreign Application Priority Data
Apr. 9, 2004 (JP) JP2004-115679

(51) Int. Cl. B60R 21/16

(52) U.S. Cl. 280/743.2

(57) ABSTRACT

An airbag and an airbag system are disclosed. In one form, the airbag includes a first tether belt that connects a front panel and a rear panel together and becomes tense when the airbag inflates into a normal shape, a second tether belt that connects the front panel and the rear panel together and is shorter than the first tether belt and a third tether belt that connects the side rim and the center of the rear panel together. The airbag first inflates into a form in which the inflation toward the occupant and in the lateral direction is restrained by the second tether belt and the third tether belt. Thereafter, when the airbag inflates into a normal shape, both of the second tether belt and the third tether belt release the restraint; when the airbag inflates into an abnormal shape, only the third tether belt releases the restraint.

### FIELD OF THE INVENTION

The present invention relates to an airbag and an airbag system mounted in high-speed movable bodies, such as vehicles, and in particular, it relates to an airbag and an airbag system including an improved tether belt for restraining the inflation of the airbag.

### BACKGROUND OF THE INVENTION

In case of a frontal collision of a car when an occupant is seated ahead of a normal seating position such as resting against a steering or an instrument panel (this is sometimes called “an out-of-position state”), the occupant sometimes strikes against an airbag in the process of inflation in an earlier stage than that when the airbag inflates into a normally inflated shape (fully inflated shape).

Japanese Unexamined Patent Application Publication No. 2000-142290 describes an airbag having a tether belt for restraining the inflation of an airbag, which first inflates into a shape restrained by the tether belt and further inflates into a normal shape by the relief of the restraint by the tether belt owing to the following increase in inner pressure.

The airbag of the reference will be described hereinbelow in detail.

The tether belt of the reference for restraining the inflation of the airbag is in the shape of a cross including a longitudinal belt that connects the occupant side (the front face) of the airbag and the opposite side (rear portion) of the occupant and a lateral belt that connects the left and right sides of the airbag.

The longitudinal belt is folded in two at two portions in its extending direction and stitched together by fuse stitch and so decreased in length. The fuse stitch is constructed to be broken when the inner pressure of the airbag increases to apply a tension higher than a specified level to both ends of the longitudinal belt, thereby increasing the longitudinal belt in length. The longitudinal belt reaches a length that the belt becomes tense when the airbag inflates into a normal shape (when the airbag has fully inflated without receiving the occupant in the process of inflation).

The longitudinal belt has a slit along its extending direction. The slit expands laterally to increase the distance between both ends of the lateral belt, allowing the airbag to inflate laterally and more widely.

The airbag of the reference having this tether belt is restrained from inflating toward the occupant by the tension of the longitudinal belt that is decreased in length because of fuse stitch, halfway through inflation. Accordingly, even when an occupant in out-of-position state strikes against the airbag halfway through its inflation in an early stage, the pressure of the airbag that pushes the occupant to the rear of the vehicle can be reduced.

When the occupant is seated in a normal seating position (hereinafter, referred to as “an in-position state”), there is sufficient space between the airbag and the occupant. Accordingly, after inflating into a shape restrained by the longitudinal belt that is decreased in length by fuse stitch, the airbag is released from the restraint by the longitudinal belt because of the breaking of the fuse stitch due to an increase in inner pressure of the airbag, thus further inflating toward the occupant into a normal inflation shape.

In the airbag disclosed in the Japanese Unexamined Patent Application Publication No. 2000-142290, the slit provided in the extending direction of the longitudinal belt of the tether belt expands laterally, so that the restraint of the lateral inflation of the airbag by the lateral belt of the tether belt is released, allowing the airbag to inflate laterally and more widely. In order to expand the slit laterally, the occupant must move the front face of the airbag backward toward the rear to decrease the distance between both ends of the longitudinal belt.

However, when the occupant strikes against the airbag halfway through its inflation, the airbag becomes flat with a decreased volume in appearance and also the airbag is supplied with gas sufficient to inflate the airbag fully into a normal shape even after receiving the occupant and as such, the inner pressure of the airbag becomes relatively high. As a result, it becomes difficult for the occupant to move the front face back to the rear, preventing the airbag from fully inflating laterally and as such, an impact to the occupant may not be absorbed sufficiently.

### SUMMARY OF THE INVENTION

Accordingly, it is an object of the present invention to provide an airbag and an airbag system capable of protecting an occupant sufficiently even when the occupant is seated close to the airbag system.

An airbag according to one form of the invention comprises restraint means for restraining the inflation shape of an airbag. In inflation, the airbag first inflates into a form restrained by the restraint means and is then released from the restraint by the restraint means due to the following increase in inner pressure to inflate further into a larger form. The restraint means does not release the restraint of inflation of the airbag toward an occupant and releases the restraint of lateral inflation of the airbag when the airbag inflates into an abnormal shape.

In the airbag according to a preferred form, the restraint means comprises: a first tether belt connecting the occupant side of the airbag and the opposite side thereof and becoming tense when the airbag inflates into a normal shape; a second tether belt connecting the occupant side of the airbag and the opposite side thereof and being shorter than the first tether belt; and a third tether belt connecting the side and the center of the airbag. When the airbag inflates, the second tether belt and the third tether belt first become tense to restrain the inflation of the airbag toward the occupant and lateral inflation. When the airbag then increases in inner pressure to inflate into a normal shape, both of the second tether belt and the third tether belt release the restraint. When the airbag inflates into an abnormal shape, only the third tether belt releases the restraint.

The airbag according to another preferred form further comprises an inflation-shape-corresponding vent hole that is closed or slightly opened when the airbag inflates into a normal shape and opened or widely opened when the airbag inflates into an abnormal shape.

The airbag according to another form further comprises a normally-open vent hole for communicating the inside and outside of the airbag irrespective of the inflation shape of the airbag.

In the airbag according to a preferred form, the inflation-shape-corresponding vent hole has a cover that releases the closing or opens widely when the airbag inflates into an abnormal shape.

In the airbag according to another preferred form, the cover has a small vent hole for communicating the inside and outside of the airbag, the vent hole having an opening area smaller than that of the inflation-shape-corresponding vent hole.

In the airbag according to another form, the cover releases the closing or opens widely when the airbag inflates laterally by more than a specified amount.

In the airbag according to one form, the inflation-shape-corresponding vent hole is provided in a position laterally apart from the center of the airbag; the cover member detachably connects to the vicinity of the inflation-shape-corresponding vent hole so as to cover the vent hole; the third tether belt connects to the cover at one end and connects to the center of the airbag at the other end; and when the airbag inflates, the third tether belt first becomes tense between the cover and the center of the airbag to restrain the lateral inflation of the airbag, and when the airbag thereafter inflates laterally by more than a specified amount, the connection between the cover and the vicinity of the vent hole is released and as such, the restraint of the lateral inflation of the airbag by the third tether belt is released and the inflation-shape-corresponding vent hole is released or opened widely.

In the airbag according to a preferred form, when the airbag inflates into a normal shape, the connection between the cover and the vent hole is not released and the connection between the third tether belt and the center of the airbag is released.

An airbag system according to the invention comprises the airbag according to the invention and an inflator for inflating the airbag.

In the invention, the phrase that the airbag inflates into a normal shape denotes that the airbag inflates fully without receiving an occupant in the process of inflation; the phrase that the airbag inflates into an abnormal shape means that the airbag inflates while receiving the occupant before the airbag inflates fully (in the process of inflation). In the invention, the lateral direction means a direction that intersects a direction connecting the occupant side of the airbag and the opposite side thereof (e.g., the upper, lower, left, or right as viewed from the occupant).

With an airbag and airbag system according to the invention, the inflation of the airbag is once restrained by restraint means before the airbag inflates into a normal shape. Therefore, even when an occupant in an out-of-position state adjacent to the airbag strikes against the airbag halfway through inflation in an early stage, the pressure of the airbag that pushes the occupant backward can be reduced.

When the airbag inflates into an abnormal shape when the airbag receives the occupant halfway through inflation, the restraint means releases the restraint of the lateral inflation of the airbag while restraining the inflation toward the occupant. Accordingly, the airbag inflates quickly laterally and widely without inflating toward the occupant so as to push the occupant away, thereby sufficiently absorbing an impact to the occupant.

According to one form, the airbag first inflates into a shape in which inflation toward the occupant and lateral inflation are restrained by a second tether belt connecting the occupant side of the airbag and the opposite side thereof and a third tether belt connecting the side and the center of the airbag. When the occupant strikes against the airbag halfway through inflation at an early stage, so that the airbag inflates into an abnormal shape, the restraint of the inflation of the airbag toward the occupant by the second tether belt is not released but the restraint of the lateral inflation of the airbag by the third tether belt is released. Accordingly, the airbag inflates quickly laterally and widely without inflating toward the occupant so as to push the occupant away.

When the airbag inflates into a shape restrained by the second tether belt and the third tether belt and then the airbag halfway through inflation inflates into a normal shape without receiving the occupant, both of the restraint of the inflation of the airbag toward the occupant by the second tether belt and the restraint of the lateral inflation by the third tether belt are released, so that the airbag inflates fully.

With the structure as described above, the restraint of the inflation toward the occupant and the lateral inflation of the airbag and the release of the restraint can be controlled by a simple structure using the tether belts.

According to a preferred form, when the airbag inflates into an abnormal shape, an inflation-shape-corresponding vent hole is opened or widely opened to increase the amount of gas flowing from the airbag through the vent hole. This allows an impact also to an occupant close to the airbag to be absorbed sufficiently. This also reduces the pressure of the airbag to push the occupant to the rear of the vehicle.

With the airbag according to another form, further comprising a normally-open vent hole for communicating the inside and outside of the airbag irrespective of the inflation shape of the airbag, gas flows out through the normally-open vent hole solely or in principal at a normal-shape inflation, while the gas flows out quickly through both of the normally-open vent hole and the inflation-shape-corresponding vent hole at an abnormal-shape inflation.

According to a preferred form, the inflation-shape-corresponding vent hole has a cover that releases the closing or opens widely when the airbag inflates into an abnormal shape. Thus, the gas flow amount through the inflation-shape-corresponding vent hole is increased by the opening action of the cover.

According to another form, the cover has a small vent hole with an opening area smaller than that of the inflation-shape-corresponding vent hole. In this case, when the airbag inflates into a normal shape, the gas in the airbag flows out through the small vent hole. When the airbag inflates into an abnormal shape, the gas flows out quickly through the inflation-shape-corresponding vent hole which is released from closing or opened widely by the cover.

According to one form, the cover releases the closing or opens widely when the airbag inflates in the lateral direction by more than a specified amount. The lateral direction denotes a direction that intersects the direction connecting the base end of the airbag to the occupant (e.g., the upper, lower, left, or right viewed from the occupant). With this structure, the inflation-shape-corresponding vent hole is released or opened widely when the airbag inflates into an abnormal shape.

According to a preferred form, the inflation-shape-corresponding vent hole is provided in a position laterally apart from the center of the airbag (at the side of the airbag) and the cover for covering the vent hole connects to the end of the third tether belt adjacent to the side of the airbag. Accordingly, the airbag inflates laterally by more than a specified amount, the cover member is drawn by the third tether belt toward the center of the airbag, so that the connection between the cover and the vicinity of the vent hole is released. Accordingly, when the airbag inflates into an abnormal shape, the vent hole is released or widely opened in operative association with the release of the restraint of the lateral inflation of the airbag by the third tether belt.

According to another form, when the airbag inflates into a normal shape, the connection between the third tether belt and the center of the airbag is released but the connection between the cover and the vicinity of the vent hole is not released. Accordingly, although the restraint of the lateral inflation of the airbag by the third tether belt is released, the inflation-shape-corresponding vent hole remains closed or slightly opened.

### BRIEF DESCRIPTION OF THE DRAWINGS

FIG. 1 is a plan view of an airbag according to an embodiment of the present invention, showing a rear panel.

FIG. 2 is a cross-sectional perspective view taken along line II-II of FIG. 1.

FIG. 3 is a cross-sectional view taken along line 111-111 of FIG. 1.

FIG. 4 is a cross-sectional view of the same part as FIG. 3, showing the airbag of FIG. 1 halfway through inflation into a normal shape.

FIG. 5 is an overall cross-sectional view of the airbag of FIG. 1 inflated into a normal shape.

FIG. 6 is a cross-sectional view of the same part as FIG. 3, showing the airbag in FIG. 1 halfway through inflation into an abnormal shape.

FIG. 7 is an overall cross-sectional view of the airbag of FIG. 1 inflated in an abnormal shape.

FIG. 8 is diagrams showing other structural examples of an inflation-shape-corresponding second vent hole.

FIG. 9 shows the structure of threads.

FIG. 10 is a plan view of a rear panel of an airbag according to another embodiment of the invention.

FIG. 11 is a cross-sectional view taken along line XI-XI of FIG. 10.

FIG. 12 is a cross-sectional view of the same part as FIG. 11, showing the state of the airbag in FIG. 10 halfway through inflation into a normal shape.

FIG. 13 is a cross-sectional view of the same part as FIG. 11, showing the state of the airbag in FIG. 10 halfway through inflation into an abnormal shape.

### DETAILED DESCRIPTION OF THE PREFERRED EMBODIMENTS

Embodiments of the present invention will be described with reference to the drawings.

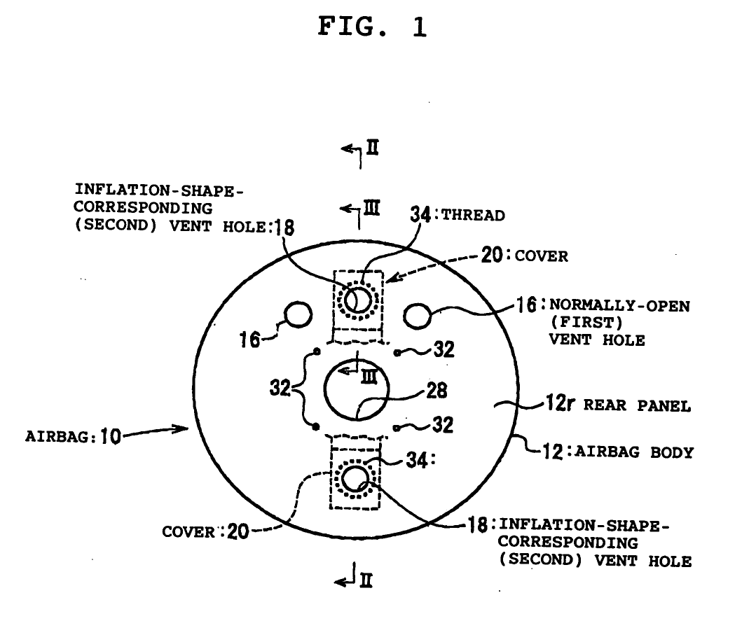

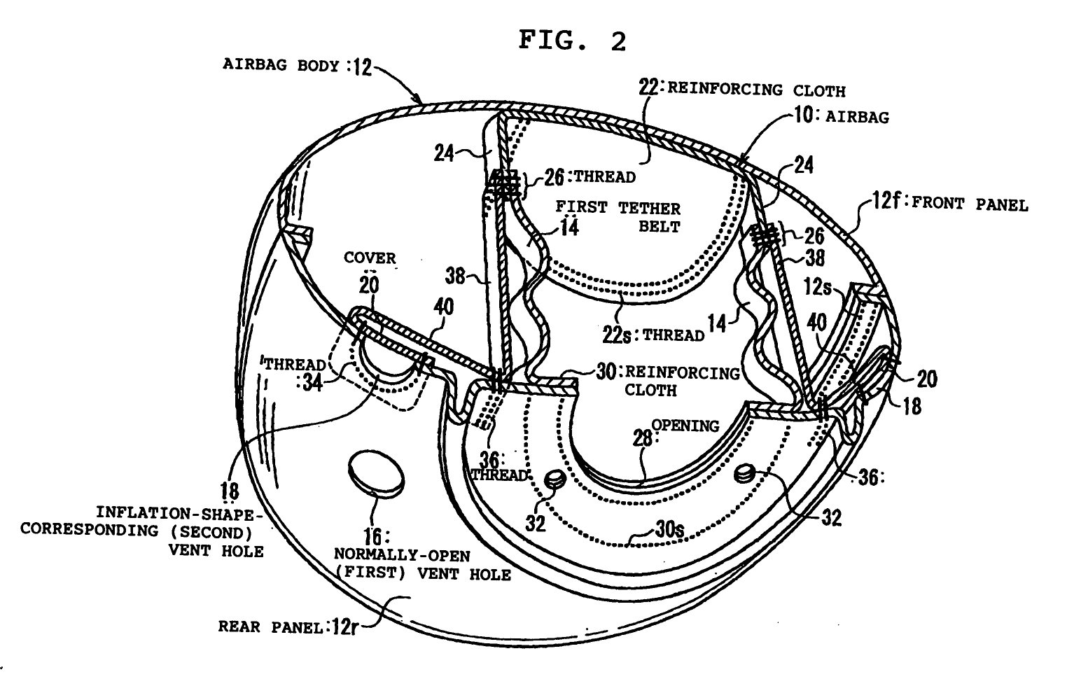

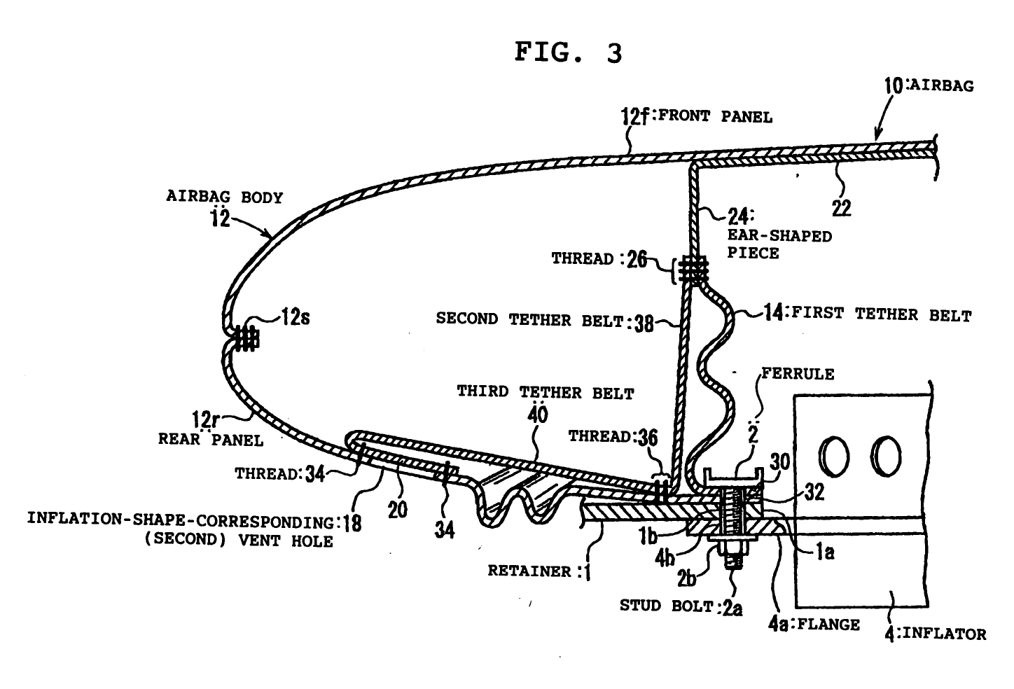

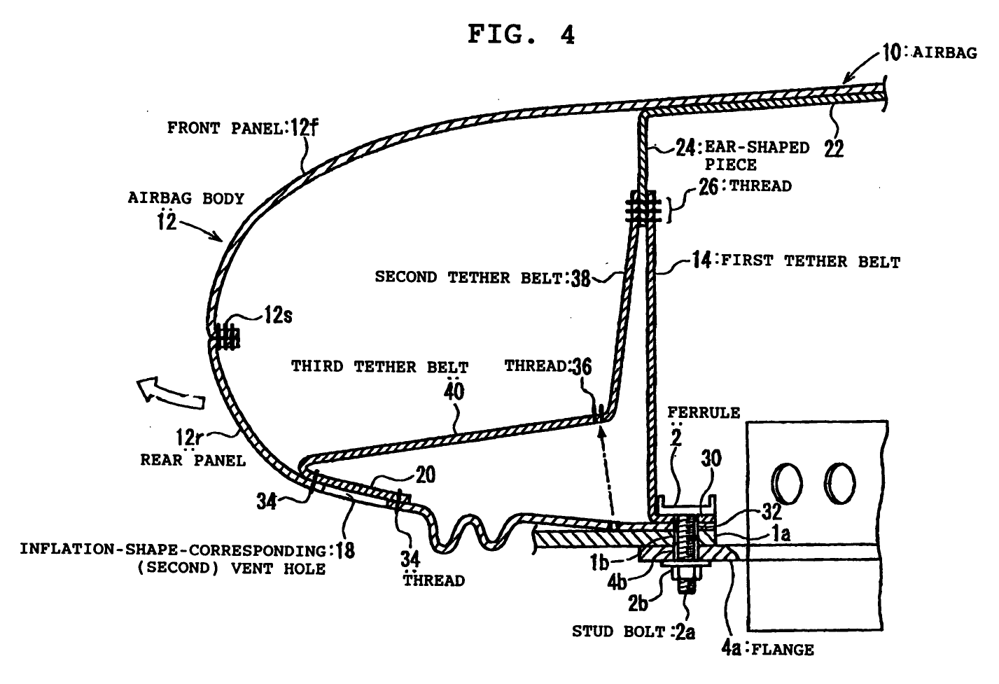

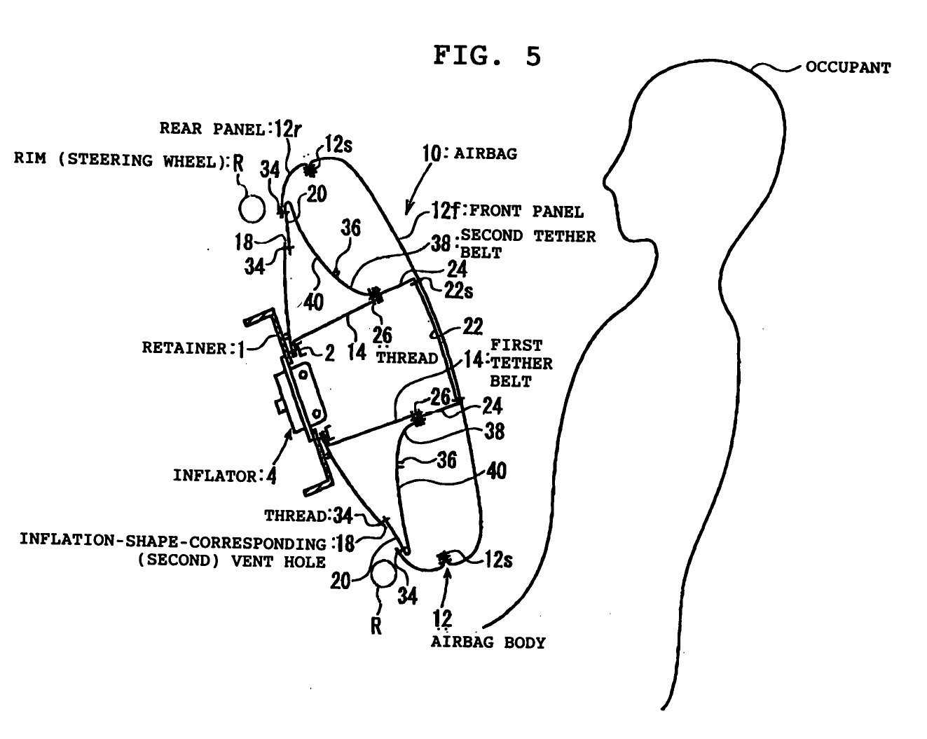

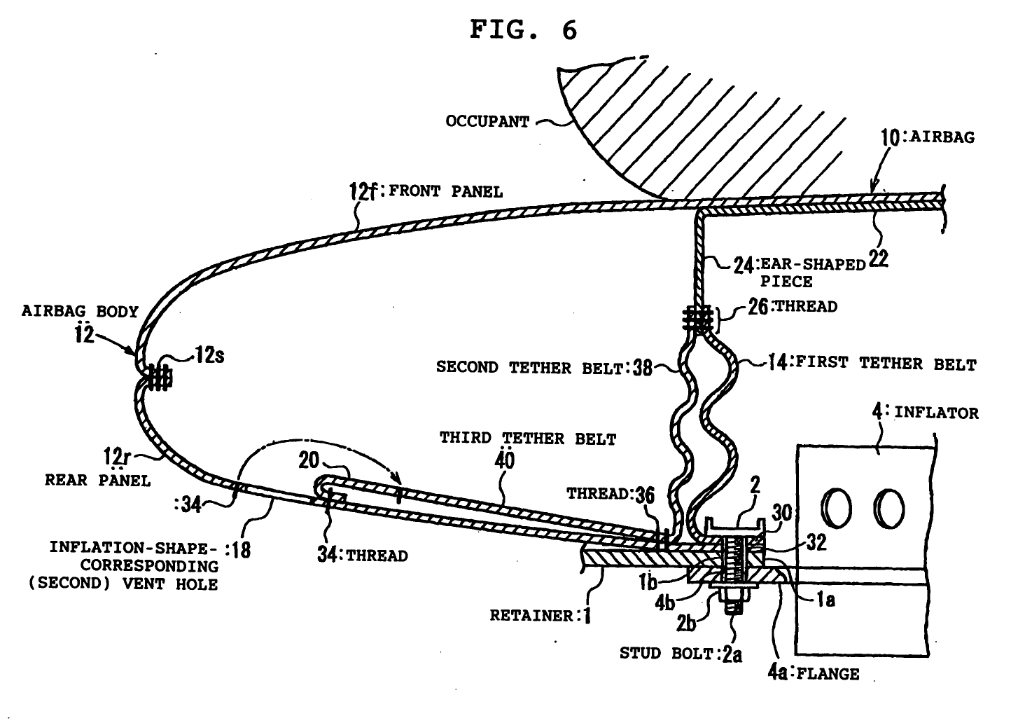

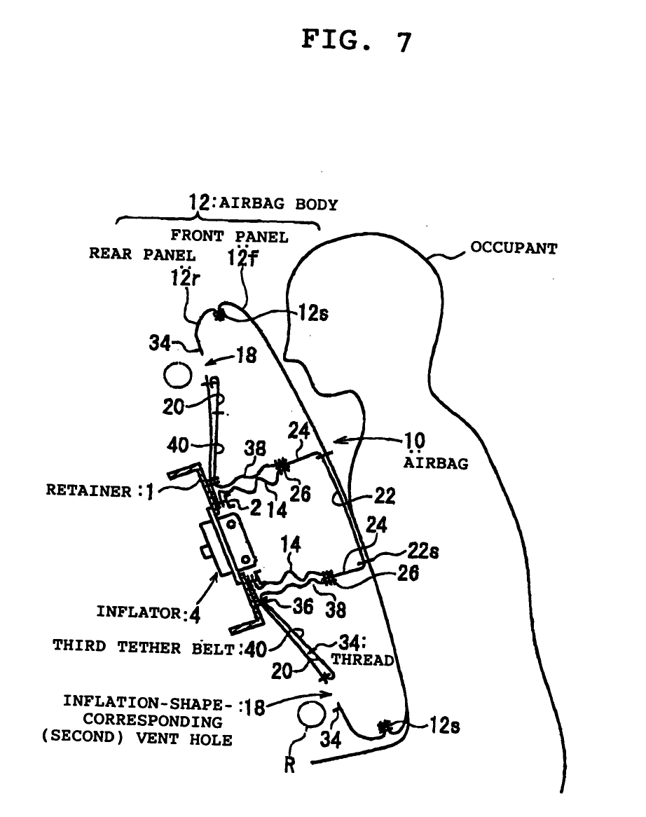

FIG. 1 is a plan view of an airbag according to an embodiment of the present invention, showing a rear panel. FIG. 2 is a cross-sectional perspective view taken along line II-II of FIG. 1. FIG. 3 is a cross-sectional view taken along line III-III of FIG. 1, showing the airbag halfway through inflation into a normal shape (a first stage). FIG. 4 is a cross-sectional view of the same part as FIG. 3, showing the airbag halfway through inflation into a normal shape (a second stage). FIG. 5 is an overall cross-sectional view of the airbag inflated into a normal shape. FIG. 6 is a partial cross-sectional view of the airbag halfway through inflation into an abnormal shape. FIG. 7 is an overall cross-sectional view of the airbag inflated into an abnormal shape.

An airbag 10 according to the embodiment is a car driver-seat airbag.

The airbag 10 comprises an airbag body 12 that is made in such a manner that the peripheries of a front panel 12f and a rear panel 12r, which are made of a substantially circular fabric, are stitched together by a thread 12s, a first tether belt 14 that connects the center of the front panel 12f and the center of the rear panel 12r and becomes tense when the airbag 10 inflates into a normal shape, a second tether belt 38 that connects the center of the front panel 12f and the center of the rear panel 12r and is shorter than the first tether belt 14, and a third tether belt 40 that connects the side rim and the center of the rear panel 12r.

The rear panel 12r of this embodiment has a normally-open vent hole (hereinafter, sometimes referred to as a first vent hole) for communicating the inside and outside of the airbag 10 irrespective of the inflation shape of the airbag 10, an inflation-shape-corresponding vent hole (hereinafter, sometimes referred to as a second vent hole) 18 for communicating the inside and outside of the airbag 10 such that it is closed when the airbag 10 inflates into a normal shape and is opened when the airbag 10 inflates into an abnormal shape, and a cover 20 for closing the inflation-shape-corresponding vent hole 18 when the airbag 10 inflates into a normal shape and opening the inflation-shape-corresponding vent hole 18 when the airbag 10 inflates into an abnormal shape.

As shown in FIG. 2, the embodiment includes a pair of upper and lower (two in total) first tether belts 14 so as to connect the upper and lower parts in the center of the front panel 12f and the rear panel 12r (the upper and lower parts correspond to those in FIG. 1, the same applies to the following description), respectively.

The front panel 12f has a reinforcing cloth 22 at the center thereof. Reference numeral 22s indicates a thread for sewing the periphery of the reinforcing cloth 22 on the front panel 12f. An ear-shaped piece 24 for connecting the tether belt projects from the upper and lower peripheries of the reinforcing cloth 22. The end of the first tether belt 14 is sewn on the ear-shaped piece 24 by a thread 26.

The rear panel 12r has an inflator-engaging opening 28, around which a ring-shaped reinforcing cloth 30 is sewn by a thread 30s. Around the opening 28, through holes 32 are provided such that they pass through the reinforcing cloth 30 and the rear panel 12r. The through holes 32 are disposed at regular intervals around the opening 28.

The base end of the first tether belt 14 continues to the upper or lower periphery of the reinforcing cloth 30.

As shown in FIG. 1, a total of two first vent holes 16 are provided in the upper left half and right half of the rear panel 12r. A total of two second vent holes 18 are provided in the lateral center of the rear panel 12r adjacent to the upper rim (between the first vent holes 16) and in the lateral center of the rear panel 12r adjacent to the lower rim. The second vent holes 18 each have the cover 20.

The covers 20 are placed on the rear panel 12r so as to cover the second vent holes 18 and sewn on the peripheries of the second vent holes 18 by a thread 34. The stitch of the cover 20 by the thread 34 is formed around the entire peripheries of the second vent holes 18.

In this embodiment, the end of the third tether belt 40 (the end adjacent to the side rim of the rear panel 12r) continues to the cover 20. In other words, the end of the third tether belt 40 connects to the side rim (the upper or lower rim in this embodiment) of the rear panel 12r via the cover 20. As shown in FIGS. 2 and 3, the end of the third tether belt 40 connects to the side of the cover 20 at the periphery of the rear panel 12r (located apart from the center of the rear panel 12r).

In this embodiment, the base end of the third tether belt 40 (the end adjacent to the center of the rear panel 12r) connects to the base end of the second tether belt 38 (the end adjacent to the rear panel 12r). The boundary between the third tether belt 40 and the second tether belt 38 is sewn on the center of the rear panel 12r by a thread 36 so as to be located near the base end of the first tether belt 14. The end of the second tether belt 38 (the end adjacent to the front panel 12f) and the end of the first tether belt 14 are sewn on the ear-shaped piece 24 of the reinforcing cloth 22 by the thread 26.

The second tether belt 38 in a tense condition is shorter than the first tether belt 14 in a tense condition. Therefore, when the airbag 10 inflates, the second tether belt 38 becomes tense between the front panel 12f and the rear panel 12r earlier than the first tether belt 14 as the front panel 12f starts to inflate toward the occupant while separating from the rear panel 12r.

The length of the third tether belt 40 in a tense condition is smaller than the distance from the center of the rear panel 12r in a flat state (a portion where the thread 36 is sewn on) to the periphery of the second vent hole 18. Therefore, when the airbag 10 inflates, the rear panel 12r is restrained by the third tether belt 40 from deploying laterally (radially) between the center of the rear panel 12r and the periphery of the second vent hole 18.

The connection of the boundary (the base ends) between the third tether belt 40 and the second tether belt 38 by the thread 36 to the rear panel 12r is broken when the tension generating in the second tether belt 38 reaches a specified value when the airbag 10 is going to inflate into a normal shape (when the front panel 12f starts to inflate toward the occupant while separating from the rear panel 12r with the inflation of the airbag 10, so that the second tether belt 38 becomes tense earlier than the first tether belt 14, and then the front panel 12f starts to inflate toward the occupant while separating from the rear panel 12r).

The connection of the distal ends of the second tether belt 38 and the first tether belt 14 to the ear-shaped piece 24 by the thread 26 is firmer than that by the thread 36 so that it is not broken even when the tension that generates in the second tether belt 38 exceeds the specified value.

The connection of the cover 20 to the periphery of the second vent hole 18 by the thread 34 is less firm than that by the thread 36. Accordingly, when the tension that generates in the third tether belt 40 for restraining the sideward deployment of the rear panel 12r has reached a specified value in the case where the airbag 10 is going to inflate into a laterally expanded form (in an abnormal shape) more than a normal shape (when the airbag 10 is going to inflate laterally in principal so as to deploy the rear panel 12r laterally and widely from a state in which the lateral deployment of the rear panel 12r is restrained by the third tether belt 40), the connection by the thread 34 is broken earlier than that by the thread 36. In this case, the cover 20 comes off from the periphery of the second vent hole 18 to open the second vent hole 18.

In this embodiment, the threads 26, 34, and 36 are made of the same material and of the same standards, such as the thickness and strength. For example, only one seam of the thread 34 is formed which sews the cover 20 on the periphery of the second vent hole 18, two seams of the thread 36 are formed which sew the boundary (the base ends) between the third tether belt 40 and the second tether belt 38 on the rear panel 12r, and three seams of the thread 26 are formed which sew the distal end of the second tether belt 38 on the ear-shaped piece 24 so that the respective connection strengths differ from one another. In that case, the number of the seam lines of the threads 26, 34, and 36 has only to satisfy (the number of the seam lines of the thread 26)>(the number of the seam lines of the thread 36)>(the number of the seam lines of the thread 34) and is not limited to the foregoing number of seams.

The airbag 10 is mounted to an automobile driver-seat airbag system. The airbag system includes a retainer 1 for retaining the airbag 10, a ferrule 2 for fixing the airbag 10 to the retainer 1, an inflator 4 for supplying inflation gas to the airbag 10.

In this embodiment, the ferrule 2 has a stud bolt 2a.

The retainer 1 has an inflator-fixing opening 1a. The inflator-fixing opening 1a has a bolt hole lb in the periphery for the stud bolt 2a to pass through.

The inflator 4 has a flange 4a that agrees with the periphery of the inflator-fixing opening 1a. The flange 4a has a bolt hole 4b for the stud bolt 2a to pass through.

The airbag 10 is placed on the retainer 1 such that the inflator-engaging opening 28 is centered at the identical point to the inflator-fixing opening 1a of the retainer 1, on which the ferrule 2 is placed. At that time, the stud bolt 2a is passed through the through hole 32 of the airbag 10, the bolt hole 1b of the retainer 1, and the bolt hole 4b of the flange 4a. Then, a nut 2b is tightened on the stud bolt 2a to fix the ferrule 2 to the retainer 1 and as such, the rim of the opening 28 of the airbag 10 is clamped between the ferrule 2 and the retainer 1.

After the airbag 10 and the inflator 4 have been mounted to the retainer 1, the airbag 10 is folded, over which a module cover (not shown) is covered and fixed to the retainer 1, then the airbag system is completed.

The airbag system is mounted to the steering wheel of a car (only a rim R is shown in FIGS. 5 and 7).

The operation of the airbag system including the airbag 10 will then be described.

Upon detection of a frontal collision of a car, the inflator 4 is activated to emit a jet of gas. The airbag 10 starts to inflate by the gas from the inflator 4, inflating ahead of the occupant while pushing the module cover open.

As shown in FIG. 5, when the occupant is seated in a normal seating position (hereinafter, sometimes referred to as “an in-position state”) in a vehicle collision, there is sufficient space between the face of the airbag 10 facing the occupant (front panel 12f) and the occupant.

In that case, as shown in FIG. 3, the airbag 10 inflates, in the initial state of the inflation, until the second tether belt 38 shorter than the first tether belt 14 becomes tense between the front panel 12f and the rear panel 12r of the airbag 10 earlier than the first tether belt 14. In the state of FIG. 3, the front panel 12f is held by the second tether belt 38, so that the airbag 10 is located on this side (close to the rear panel 12r) than in a normal shape.

Referring to FIG. 3, the airbag 10 is in a laterally deployed state in which the third tether belt 40 is tense between the center of the airbag 10 and the periphery of the second vent hole 18. The rear panel 12r has remaining slack between the thread 34 and the thread 36.

With the occupant in position (in a normal position), the airbag 10 further inflates from the state of FIG. 3 toward the occupant before the occupant strikes against the airbag 10. At that time, as shown in FIG. 4, the connection between the second tether belt 38 and the rear panel 12r by the thread 36 is broken to release the restraint by the second tether belt 38, so that the front panel 12f further inflates toward the occupant. The front panel 12f separates from the rear panel 12r until the first tether belt 14 becomes tense. The breaking of the connection by the thread 36 releases the restraint by the third tether belt 40, so that the rear panel 12r further deploys laterally. Thus, as shown in FIG. 5, the airbag 10 inflates into a normal shape of a high capacity. In that case, the tether belts 38 and 40 connecting to the cover 20 have slack and the second vent holes 18 are held closed by the covers 20.

When the occupant strikes against the airbag 10 that has inflated in this way from a normal seating position, the gas in the airbag 10 flows out through the normally-open first vent holes 16 to absorb an impact to the occupant.

When a car collides head-on with the occupant seated ahead of a normal seating position such as resting against a steering wheel (hereinafter, sometimes called “an out-of-position state”), the occupant strikes against the airbag 10 in the process of inflation in an earlier stage than when the airbag inflates into the state of FIG. 3. FIGS. 6 and 7 show the state at that time (an abnormal-shape inflated state).

In the state of FIGS. 6 and 7, the tether belts 14 and 38 are loose, so that the connection between the second tether belt 38 and the rear panel 12r by the thread 36 is not released. In that case, the third tether belt 40 becomes tense between the center of the rear panel 12r and the periphery of the second vent hole 18. Accordingly, a tension exceeding a specified level is applied to the third tether belt 40 to break the connection between the cover 20 and the periphery of the second vent hole 18 by the thread 34.

Thus, the restraint by the third tether belt 40 is released to deploy the rear panel 12r laterally and quickly. Also, the cover 20 is taken off from the periphery of the second vent hole 18 to open the second vent hole 18.

Consequently, the airbag 10 inflates quickly, widely and laterally without inflating toward the occupant so as to push the occupant to the rear of the vehicle, and the gas in the airbag 10 flows out through both of the normally-open first vent holes 16 and the second vent holes 18, thereby sufficiently absorbing an impact to the occupant. Also the pressure of the airbag 10 to push the occupant to the rear of the vehicle is reduced.

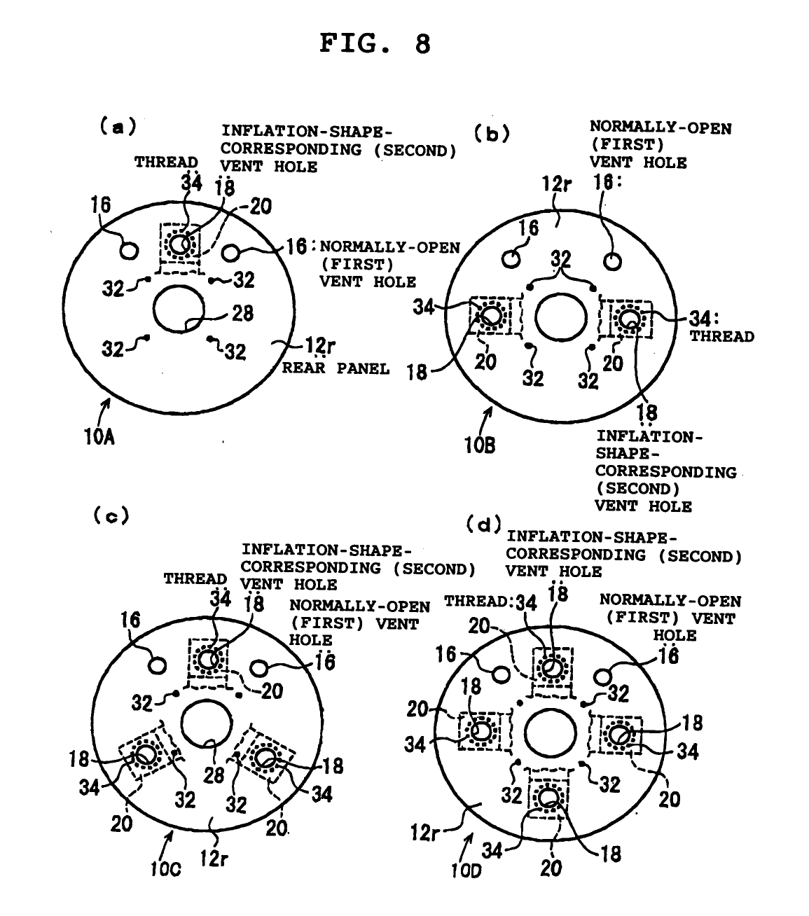

In the foregoing embodiment, the inflation-shape-corresponding second vent holes 18 are provided in the upper lateral center of the rear panel 12r of the airbag 10 (between the normally-open first vent holes 16) and in the lower lateral center of the rear panel 12r, respectively. However, the number and arrangement of the inflation-shape-corresponding second vent holes are not limited to that. Other structural examples of the inflation-shape-corresponding second vent hole will be described with reference to FIG. 8. FIGS. 8(a) to 8(d) are plan views of the rear panels of airbags, showing inflation-shape-corresponding second vent hole according to other embodiments.

In an airbag 10A of FIG. 8(a), there is only one inflation-shape-corresponding second vent hole 18 in the upper lateral center of the rear panel 12r (between the normally-open first vent holes 16).

In an airbag 10B of FIG. 8(b), there are a total of two inflation-shape-corresponding second vent holes 18 in the vertical center of the left half and the vertical center of the right half of the rear panel 12r.

In an airbag 10C of FIG. 8(c), there are a total of three inflation-shape-corresponding second vent holes 18 in the upper lateral center of the rear panel 12r (between the normally-open first vent holes 16), in the left lower part, and in the right lower part.

In an airbag 10D of FIG. 8(d), there are a total of four inflation-shape-corresponding second vent holes 18 in the upper lateral center of the rear panel 12r (between the normally-open first vent holes 16), in the lower lateral center, in the vertical center of the left half, and in the vertical center of the right half.

In FIGS. 8(a) to 8(d), the same reference numerals as those of FIGS. 1 to 7 indicate the same element.

The second vent holes 18 of the airbags 10A to 10D are also held closed in a normal inflated shape (in a in-position state); when they inflate in the out-of-position state, as shown in FIGS. 6 and 7, the cover 20 is taken off to open the second vent holes 18.

It is preferable for the invention that the thread 34 for sewing the cover 20 on the periphery of the second vent hole 18, the thread 26 for sewing the distal ends of the first tether belt 14 and the second tether belt 38 on the ear-shaped piece 24, and the thread 36 for sewing the boundary (the base ends) between the second tether belt 38 and the third tether belt 40 on the center of the rear panel 12r be made of the same material. This is because even when the breaking strengths of the threads 26, 34, and 36 made of the same material are decreased by age degradation, the relative breaking strengths do not change.

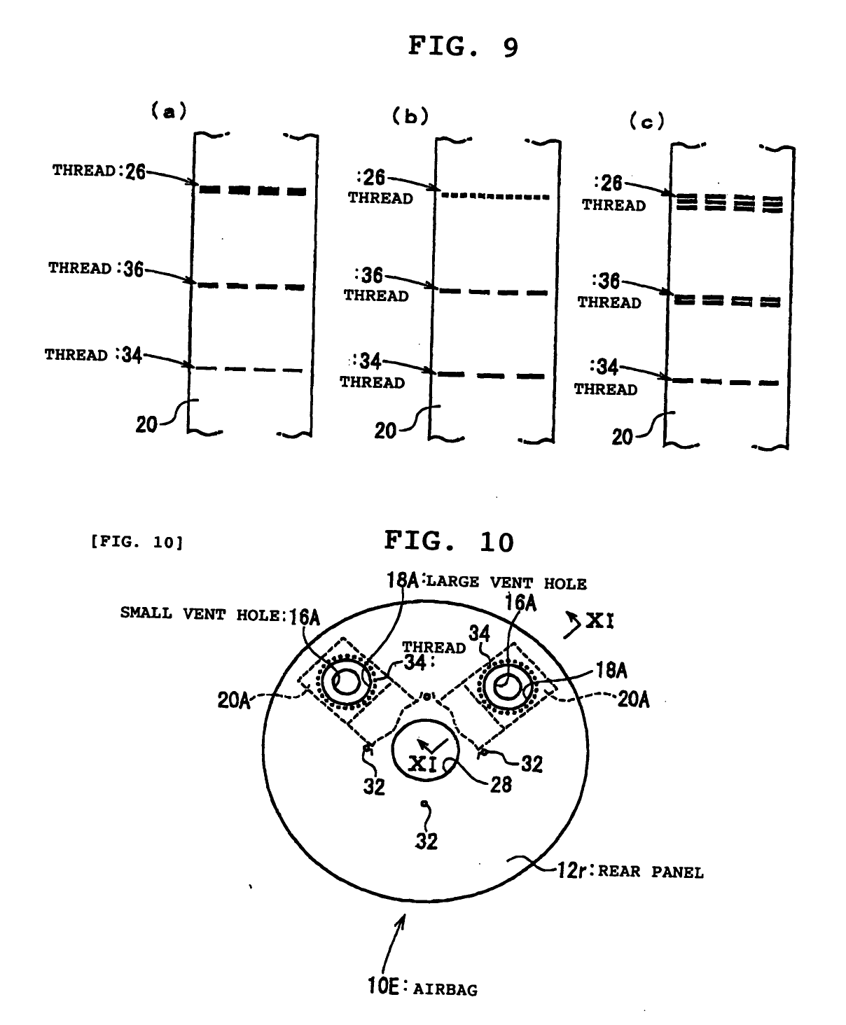

The foregoing embodiments are constructed such that, as shown in FIG. 9(c), the threads 26, 34, and 36 are made of the same material and of the same standards, such as the thickness and strength, and can satisfy (the number of the seam lines of the thread 26)>(the number of the seam lines of the thread 36)>(the number of the seam lines of the thread 34) so as to satisfy (the connecting strength by the thread 26)>(the connecting strength by the thread 36)>(the connecting strength by the 34). Alternatively, as shown in FIG. 9(a) for example, the threads 26, 34, and 36 can satisfy (the connecting strength by the thread 26)>(the connecting strength by the thread 36)>(the connecting strength by the thread 34) by using three kinds of threads made of the same material that satisfy (the thickness of the thread 26)>(the thickness of the thread 36)>(the thickness of the thread 34). Also, as shown in FIG. 9(b), the threads 26, 34, and 36 may be made of the same material and of the same standards, such as the thickness and strength, and satisfy (the connecting strength by the thread 26)>(the connecting strength by the thread 36)>(the connecting strength by the thread 34) so as to satisfy (the sewing pitch of the thread 26)>(the sewing pitch of the thread 36)>(the sewing pitch of the thread 34).

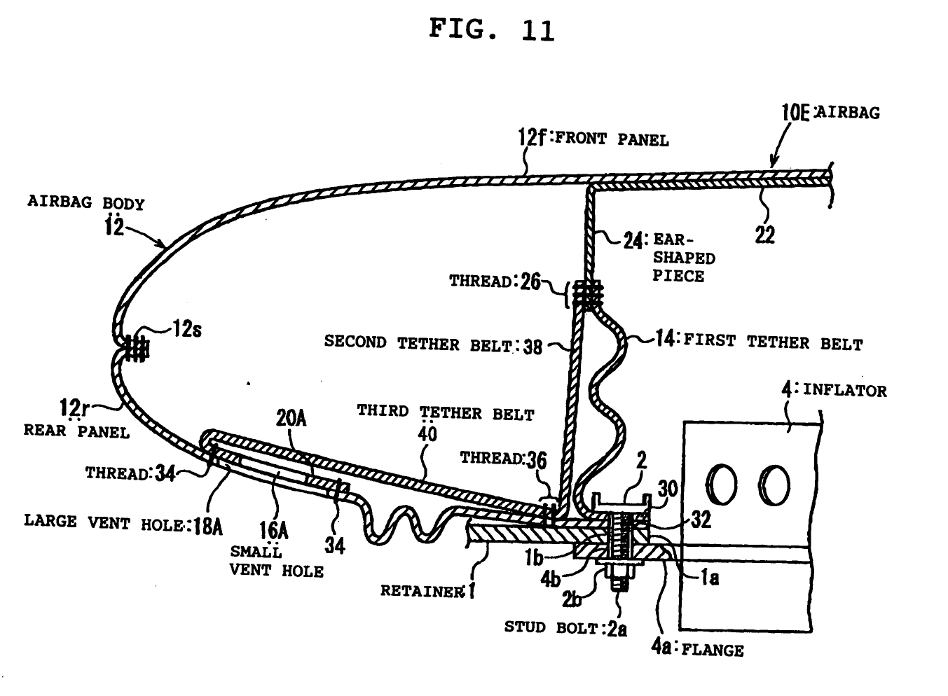

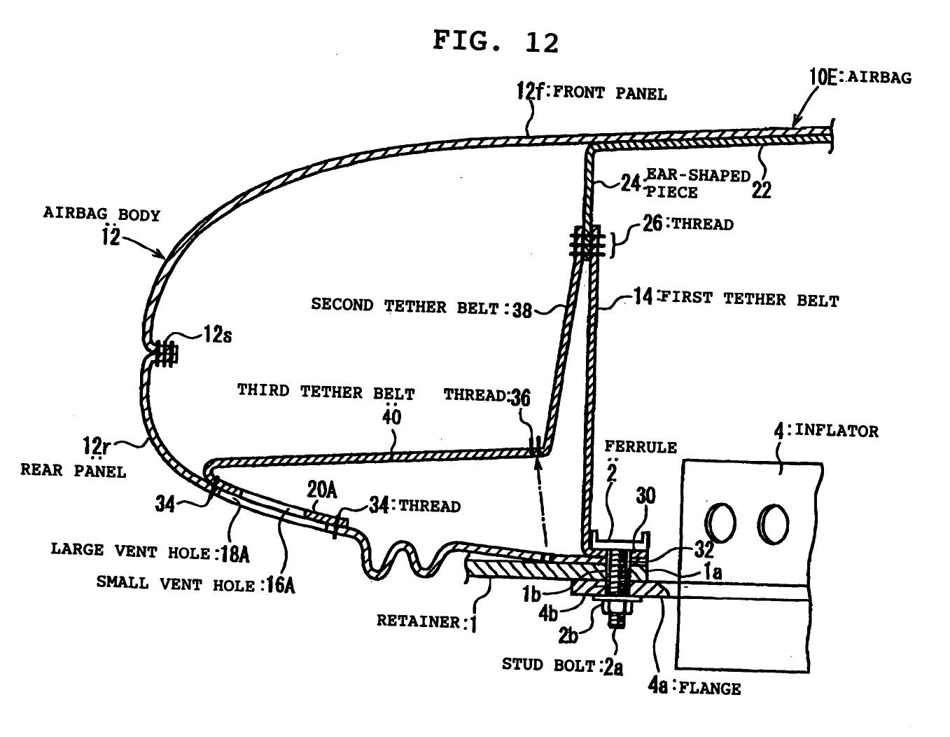

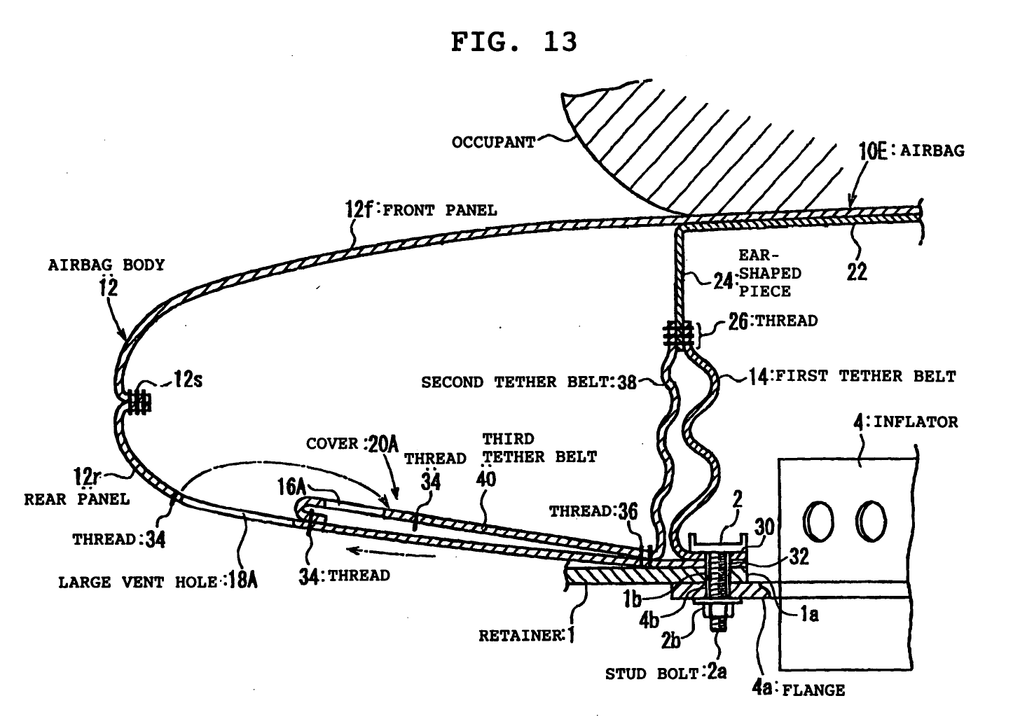

FIG. 10 is a plan view of the rear panel of an airbag according to another embodiment of the invention. FIG. 11 is a cross-sectional view taken along line XI-XI of FIG. 10, showing the state of the airbag halfway through inflation into a normal shape (a first stage). FIG. 12 is a cross-sectional view of the same part as FIG. 11, showing the state of the airbag halfway through inflation into a normal shape (a second stage). FIG. 13 is a cross-sectional view of the same part as FIG. 11, showing the state of the airbag halfway through inflation into an abnormal shape.

In this embodiment, the rear panel 12r has only an inflation-shape-corresponding vent hole 18A (hereinafter, sometimes referred to as a large vent hole) which is covered with a cover 20A when the airbag 10E inflates into a normal shape and which is fully opened when the airbag 10E inflates into an abnormal shape. The rear panel 12r has no normally-open vent hole.

As shown in FIG. 10, the embodiment has a total of two large vent holes 18A at a left oblique upper part and a right oblique upper part of the rear panel 12r, respectively.

The cover 20A has the same structure as the cover 20 except that it has a small vent hole 16A (corresponding to the normally-open first vent hole 16 in the embodiment of FIGS. 1 to 7) with a smaller opening area than the large vent hole 18A, which always communicates the inside and outside of the airbag 10E irrespective of the inflation form of the airbag 10E. (That is, the cover 20A of this embodiment also connects to the third tether belt 40). The other structures of the airbag 10E and the structure of a driver-seat airbag system including the airbag 10E are the same as those of the embodiment of FIGS. 1 to 7. In FIGS. 10 to 13, the same reference numerals as those of FIGS. 1 to 7 denote the same elements.

The operation of the airbag system including the airbag 10E will now be described.

The inflating action of the airbag 10E in an in-position state is the same as that of airbag 10. FIG. 12 shows the airbag 10E halfway through inflation in an in-position state, showing the first tether belt 14 in a tense condition. The airbag 10E thereafter inflates laterally until the slack of the rear panel 12r disappears into a fully inflated state. Also in the fully inflated state, the cover 20A is held covered over the large vent hole 18A, so that the inside and outside of the airbag 10E are communicated with each other only with the small vent hole 16A.

When an occupant in position strikes against the inflated airbag 10E, gas in the airbag 10E flows out through the normally-open small vent hole 16A, thus absorbing an impact applied to the occupant.

When an occupant in out-of-position state strikes against the airbag 10E earlier than the state of FIG. 11, the airbag 10E inflates laterally, as shown in FIG. 13.

Referring to FIG. 13, the third tether belt 40 becomes tense between the center of the rear panel 12r and the periphery of the large vent hole 18A. Thus, the connection between the cover 20A and the periphery of the large vent hole 18A by the thread 34 is broken, so that the rear panel 12r inflates laterally quickly. The cover 20A is drawn toward the center of the rear panel 12r by the third tether belt 40 to be taken off from the periphery of the large vent hole 18A and as such, the large vent hole 18A is fully opened.

Also when the airbag 10E inflates into such an abnormal shape, the large vent hole 18A with a larger opening area than the small vent hole 16A is fully opened. Accordingly, the gas in the airbag 10E flows out quickly through the large vent hole 18A, thus absorbing an impact to the occupant sufficiently. Also the pressure of the airbag that pushes the occupant to the rear of the vehicle can be reduced.

In this embodiment, a total of two circular large vent holes 18A are provided at the left oblique upper part and the right oblique upper part of the rear panel 12r of the airbag 10E. However, the structure of the large vent hole 18A, such as the number, arrangement, and shape, is not limited to that. Also the structure of the small vent hole 16A, the number, arrangement, and shape, can be other than that shown in the drawings.

In the foregoing embodiments, the opening areas of the large vent hole 18A and the small vent hole 16A can be selected as appropriate depending on the volume of the airbag, the output of the inflator, etc.

It is to be understood that the foregoing embodiments are only examples of the invention and the invention is not limited to the foregoing embodiments.

1. An airbag apparatus comprising:
an airbag for being deployed and inflated in a predetermined first direction toward an occupant generally at a first distance from the airbag prior to being deployed and in a predetermined second direction transverse to the first direction;
a restraint in the airbag that is arranged and configured to cause the airbag to expand transversely in the second direction with the occupant engaged with the airbag at a second distance from the airbag less than the first distance without requiring that the occupant push the airbag opposite to the first direction.

2. The airbag apparatus of claim 1 wherein the restraint comprises a plurality of distinct tether members.

3. The airbag apparatus of claim 1 wherein the airbag has a plurality of stages of inflation in the second direction with size of the airbag at each stage defined by the restraint.

4. The airbag apparatus of claim 3 wherein the restraint includes a releasable connection that is broken after an initial stage of airbag inflation in the second direction to cause the airbag to reach a subsequent stage of airbag inflation in the second direction with the airbag size in the second direction greater at the subsequent inflation stage than at the initial inflation stage.

5. The airbag apparatus of claim 4 wherein the restraint comprises a tether member with the releasable connection being between the tether member and the airbag and being of a predetermined strength so that with the occupant at the second distance and in engagement with the deployed airbag, the releasable connection will be broken to allow the size of the airbag to increase in the second direction.

6. The airbag apparatus of claim 1 wherein the restraint includes a first releasable connection for being broken to increase airbag size in the first direction, and a second releasable connection for being broken to increase airbag size in the second direction.

7. The airbag apparatus of claim 1 wherein the restraint includes a plurality of releasable connections, with a first one of the releasable connections being broken and a second one of the connections remaining intact with the airbag inflated toward an occupant at the first distance from the airbag, and the second connection being broken and the first connection remaining intact with the airbag inflated toward an occupant at the second distance from the airbag.

8. The airbag apparatus of claim 1 wherein the restraint includes a plurality of releasable connections that have different connection strengths for being broken based on the distance at which an occupant is from the airbag prior to deployment thereof.

9. The airbag apparatus of claim 1 which the restraint includes a releasable connection for being broken so that the airbag expands in the second direction with the occupant at the second distance, and
a vent opening of the airbag that is operable to release inflation gas from the airbag with the releasable connection broken.

10. An airbag apparatus comprising
an airbag for being deployed and inflated in a predetermined first direction toward an occupant and inflated in a predetermined second direction transverse to the first direction;
a restraint operable to restrict airbag inflation in the first and second directions;
a first portion of the restraint that is operable to provide the airbag with sequential stages of inflation in the first direction with an occupant at a first distance from the airbag prior to deployment; and
a second portion of the restraint that is operable to provide the airbag with sequential stages of inflation in the second direction with an occupant at a second distance from the airbag prior to deployment with the second distance being less that the first distance.

11. The airbag apparatus of claim 10 wherein the first and second restraint portions each include a releasable connection to the airbag so that the connection is intact during an initial one of the inflation stages and the connection is broken to shift to a subsequent one of the inflation stages.

12. The airbag apparatus of claim 10 which the second restraint portion includes a releasable connection to the airbag having a predetermined strength such that the releasable connection breaks with the airbag inflated to be in engagement with the occupant at the second distance.

13. The airbag apparatus of claim 10 wherein the restraint comprises a plurality of distinct tether members.

14. The airbag apparatus of claim 10 wherein the first restraint portion includes first and second tether members with the first tether member having slack and taut conditions and the second tether member having opposite taut and slack conditions in an initial one of the inflation stages and a subsequent one of the inflation stages, respectively, of airbag inflation in the first direction with the occupant at the first distance, and the second restraint portion includes a third tether member that is arranged and configured to have initial and subsequent taut conditions so that the third tether member has different lengths in an initial one of the inflation stages and a subsequent one of the inflation stages of airbag inflation in the second direction with the occupant at the second distance.

15. The airbag apparatus of claim 14 wherein the third tether member has a releasable connection to the airbag that is broken to allow the airbag to shift from the initial inflation stage to the subsequent inflation stage in the second direction.

16. The airbag apparatus of claim 14 wherein the second and third members are formed integrally with each other.

17. The airbag apparatus of claim 10 wherein the second restraint portion has a releasable connection that is broken to allow the airbag to shift from an initial one of the inflation stages to a subsequent one of the inflation stages in the second direction.

18. The airbag apparatus of claim 10 wherein the airbag includes a first vent opening that remains open during inflation with the occupant at either the first or second distances, and a second vent opening that is only fully open during one of the inflation stages that is subsequent to an initial one of the inflation stages in the second direction with the occupant at the second distance.

19. The airbag apparatus of claim 18 wherein the first and second openings are distinct openings in the airbag.

20. The airbag apparatus of claim 18 wherein the first and second vent openings are in communication with each other.

21. The airbag apparatus of claim 20 wherein the second vent opening comprises an opening in the airbag, and the first vent opening comprises an opening in the second restraint portion aligned with a portion of the second vent airbag opening so that the first vent opening is smaller than the second vent opening.

22. The airbag apparatus of claim 10 including an inflator that supplies inflation gas to the airbag.
